(19) United States
(12) Patent Application Publication
(10) Pub. No.: US 2014/0204572 A1
(43) Pub. Date: Jul. 24, 2014

(54) System for Adapting an Existing Florescent Light Fixture with an LED Luminaire

(71) Applicant: Thomas Spinelli, Staten Island, NY (US)

(72) Inventor: Thomas Spinelli, Staten Island, NY (US)

(21) Appl. No.: 13/746,049

(22) Filed: Jan. 21, 2013

(51) Int. Cl. F21K 99/00

(52) U.S. Cl. CPC F21K 9/10
USPC 362/223

(57) ABSTRACT

A device and method for retrofitting a light fixture from a conventional fluorescent or tube or metal halide lamp, to use with a light emitting diode (LED) based lamp assembly. The lamp fixture has a magnetized flat wall curved extending outer from the base. The (LED) based lamp assembly includes a magnetized annular outer wall having a shaped outside surface that is placed into direct surface contact with the inner surface of the existing fixture, to provide an effective heat-dissipating interface to dissipate heat away from the LED module. The (LED)-based lamp assembly can direct light to 130 degrees. The (LED)-based lamp assembly provides a power source connection to the existing fixtures power source and direct connect via by means male/female connector of a novel clip.

### FIELD OF THE INVENTION

This invention relates to LED luminaires for replacing fluorescent light sources. The present invention relates generally to electrical lighting devices and systems, and more particularly to a lighting device comprising a series of light emitting diodes (LEDs) incorporated within a clear or translucent tube or rod configured for installation in a conventional fluorescent light fixture.

### BACKGROUND OF THE INVENTION

Fluorescent light fixtures are widely used in industrial, commercial, retail, institutional and office applications. One way to reduce the high operating and maintenance costs associated with older model fluorescent light fixtures is simply to replace them with newer, more efficient models. However, given the number of fixtures that would ordinarily require replacement, this solution is not be cost effective over time. The cost associated with the replacement of older fluorescent light fixtures can be reduced through retrofitting. Retrofitting involves replacing only certain parts of an existing fluorescent lighting fixture, while retaining the remainder of the fixture housing.

A conventional retrofit oftentimes require the conversion of lamp fixtures and typically involves; installing an electronic ballast into the fixture, wiring the ballast to each of the sockets, installing each socket into individual socket brackets, screwing the socket brackets into the fixture, connecting the power supply, installing reflector covers, and installing a ballast cover. Retrofit kits are widely available for this purpose and other types of conversions. However, these retrofit kits include a variety of issues such as high costs associated with the kit itself, retaining the services of an electrician, and time.

Accordingly, it is an object of the present invention to provide an LED retrofit unit that converts light fixtures utilizing conventional fluorescent lamps and ballasts to energy efficient LED lighting and not connecting to existing fixtures, ballasts, and tombstones. It is another object of the present invention to provide an LED light unit, which can be installed without the requirement of an electrician and in a time effective and simple procedure.

It is another object of the present invention to provide an LED unit that dissipates heat effectively and provides substantially more light than conventional lighting utilizing Fresnel lens technology. The present invention to provides an LED unit that comprises minimal components, which will be described in detail in this application.

High-power Light Emitting Diodes (LEDs) provide significant advantages over traditional sources of lighting. For instance, incandescent bulbs are substantially less efficient than LEDs and as a result systems that rely on LEDs as a light source consume less power than an equivalent system, which uses incandescent bulbs. As the industry addresses environmentally safer technologies the usage of LEDs are preferable to lighting such as compact fluorescent lamps (CFLs), which contain mercury. Another advantage to the use of LEDs is simply that solid-state devices which utilize LEDs possess longevity and are significantly more durable and therefore can endure much greater stress than other alternatives in the market today such as incandescent, metal halide, sodium vapor lamps or CFLs.

The expense of redesigning lighting to incorporate LEDs is significant. Thus, it is preferable to retrofit existing luminaries with a device that uses LEDs lighting to utilize the optimum advantages of LED technology. Therefore, there is a current need for a device that can be easily inserted to existing lighting hence replacing not only the inefficient lighting with more efficient technology but also replacing the existing technology with lighting that does not need to be replaced or serviced nearly as frequently and thus lowers maintenance costs as well.

### SUMMARY OF THE INVENTION

This invention is directed to retrofitting lighting fixture wherein fluorescent light sources are replaced by light emitting diodes (LED) light sources or the like. In one embodiment, a magnetize surface is utilized to form this connection. Also, the LED light sources can be used with magnetized strips in order to enhance the retrofit efficiency and desirability.

This invention is directed to a retrofit kit or lighting unit, which permits LED units to replace fluorescent lighting in conventional down-light style fixtures or surface mounted cylindrical lighting fixtures of the square or round shape. The unit includes a magnetic LED unit to fit into the existing fixture. The unit also includes wires that can connect with existing wires and a faceted lens for increasing illumination.

The invention has a built-in heat-sink, that keeps the lamp temperature within lamp specifications.

A lighting device is described having one or more high flux LEDs mounted on a heat sink within a Fresnel-like lens. The heat sink serves to transfer heat from the LEDs to the outside environment. (The safety light further includes a diffuser located between the LEDs and the outer lens.)

One aspect of the present invention is a lighting device comprising: (a) a plurality of LEDs disposed in an array; and (b) a surface having each LED mounted on a surface thereof, the surface made of a thermally conductive material to conduct heat away from the LEDs.

Another aspect of the present invention is a lighting device comprising: (a) a LED lighting unit having (a) a plurality of equispaced LEDs, each LED mounted on a surface of the heat sink, and (b) a Fresnel lens surrounding the lighting unit; whereby light emanating from the LEDs passes through the diffuser and the uniformly patterned Fresnel lens to provide a substantially uniform horizontal plane of light.

Yet another aspect of the present invention is a lighting assembly comprising: (a) a plurality of equispaced high flux LEDs; (b) a heat sink for transferring heat from the LEDs, wherein each LED is secured to the heat sink via a track on the noninterfacing surface; and (d) a lens surrounding the LEDs having a roughened surface with a random pattern of microfaceted angles on the surface, wherein the microfaceted angles diffuse the light emitted from the LEDs.

The material of construction of the LED light unit is typically a metal and engineered printed circuit board having a high thermal conductivity. Metals are typically selected from aluminum, copper, brass, bronze, iron and steel. Aluminum is particular attractive for its high thermal conductivity, light-weight, availability, and low cost. The shaped outer surface of the LED lamp device provides proper fitting of the LED lamp assembly into the lighting fixture, and provides a heat-transferring interface over substantially the entire outer surface to dissipate heat away from the LED unit. The present disclosure provides various embodiments of a retrofitted device that can be mounted into existing light fixtures. The current invention addresses a variety of concerns and improvements in the lighting industry. The current invention provides mounting ease through it magnetized outer wall and in one embodiment utilizes a plurality of recessed magnets. Another issue this invention addresses is heat dissipation where heat is effectively conducted away from a LED lights. Further this invention provides a simple means of wiring the retrofitted device into the existing electric supply of the existing fixture via common wire fasteners. The wiring from the existing fixture is couple to the LED unit via a step down ballast and a conventional male/female plug.

The foregoing has outlined rather broadly several aspects of the present invention in order that the detailed description of the invention that follows may be better understood and thus is not intended to narrow or limit in any manner the appended claims which define the invention. Additional features and advantages of the invention will be described hereinafter which form the subject of the claims of the invention. It should be appreciated by those skilled in the art that the conception and the specific embodiment disclosed may be readily utilized as a basis for modifying or designing of the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

The invention will be better understood upon reading the following Detailed Description in conjunction with the Drawing in which:

FIG. 1 illustrates a top view of an embodiment of the assembled lighting unit without the covering lens;

FIG. 2 illustrates a front view of the grooved base of the lighting unit;

FIG. 3 illustrates a top view of the assembled lighting unit with wiring plug; and

FIG. 4 illustrates a top view of the LED board.

FIG. 5 illustrates an exploded view of an embodiment of the present invention.

### DETAILED DESCRIPTION

Various embodiments of the present invention are described below, including certain embodiments relating particularly to the LED lighting unit of the present invention. It should be appreciated, however, that the present invention is not limited to any particular manner of implementation, and that the various embodiments discussed explicitly herein are primarily for purposes of illustration. For example, the various concepts discussed herein may be suitably implemented in a variety of environments involving light sources, other types of light sources not including LEDs, environments that involve both LEDs and other types of light sources in combination, and environments that involve non-lighting-related devices alone or in combination with various types of light sources.

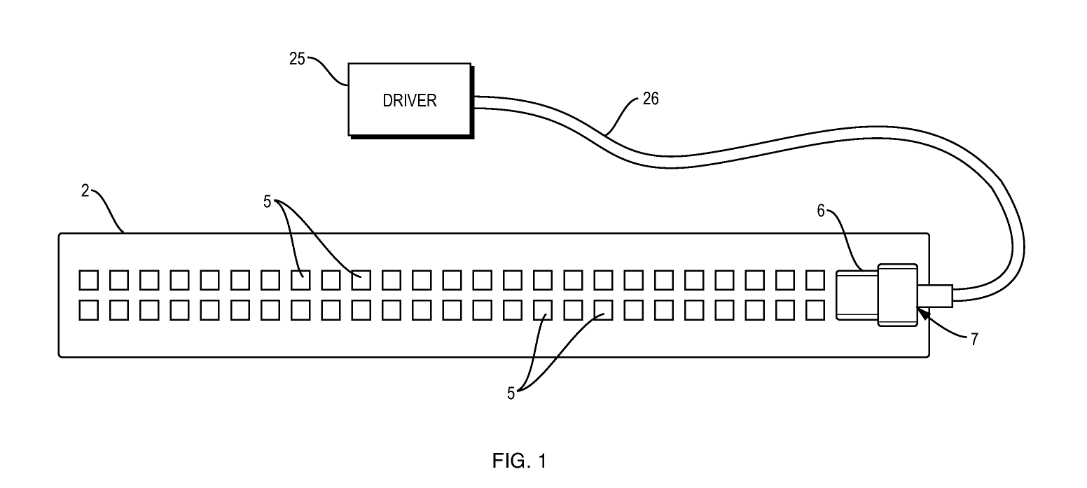

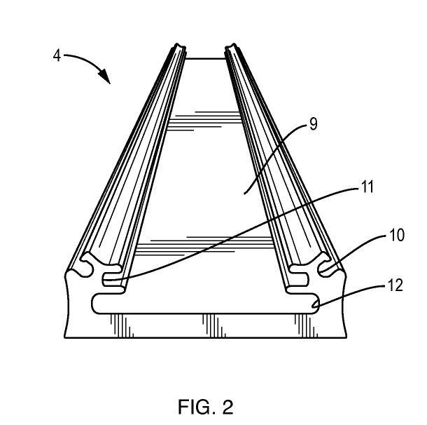

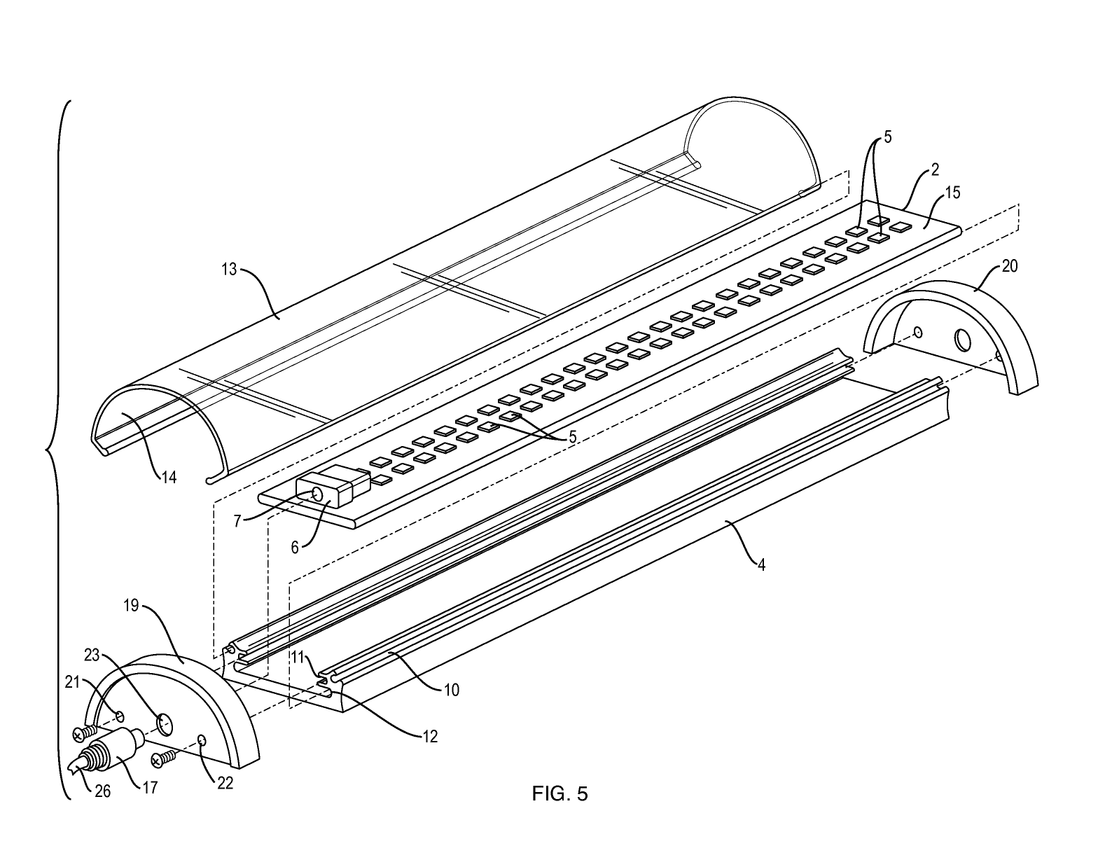

In FIG. 1 the assembled unit 1 shows the LED board 2 fitted into the grooved aspect 12 (seen in FIG. 2) of the base 4. LED board 2 in FIG. 2. is affixed to grooved aspect 12 by means of a general resin that allows for repair and replacement. About the surface of said LED board 2 are a plurality of LED receptacles 5 designed to receive a plurality of LED lights (not shown). The opposite surface of said LED board 2 (not shown) has wiring that connects each receptacle 5 to a bus 6 (not shown). Bus 6 is designed to receive a plug socket 7 (not shown) from outside said lighting unit 1 of FIG. 5. About the outer surface of said base 4 are a plurality of magnetic elements 8. Said magnetic elements 8 may be permanently affixed with a general resin or affixed with a resin that may be dissolved to allow for relocation of said magnetic elements 8 for use in different lighting applications. Said magnets 8 may be in the form of a thin or flat shape, or other geometric shapes. In another embodiment, aspects of said interfacing surface 9 of base 4 (seen in FIG. 2) may be magnetized to allow for other lighting applications. Said magnets 8 may be made of and including plastic, ceramic, ferrite, alnico, injection molded, flexible, rare earth, super conducting solenoid magnets (SMMs), and/or super conducting magnets (SCMs). The interfacing surface or interfacing aspect 9 of base 4 may include a plurality of recesses to accommodate the referred to magnets 8. Outer surface 9 of base 4 may include recesses, receptacles, channels or other mechanism to hold said magnets. A curved cover lens 13 covers said unit 1 and is shaped to be accommodated by groove 10 of said base 4 (as shown in FIG. 2.

In FIG. 2, Base 4 is shows a series of grooves. Grooved aspect 11 of said base 4 is designed to receive said LED board 2. Grooved aspect 10 of base 4 is designed to receive covering lens 13. Covering lens 13 is designed to fit tightly into said grooved aspect 13. In one embodiment the inner surface 14 of said covering lens 13 is grooved to direct light. In other embodiments inside surface 14 of covering lens 13 may be faceted or smooth. Covering lens 13 may be composed of various materials that include acrylic, polycarbonate, rigid vinyl, and glass. In another embodiment covering lens 13 may also be designed with various prismatic angles to direct light in various applications.

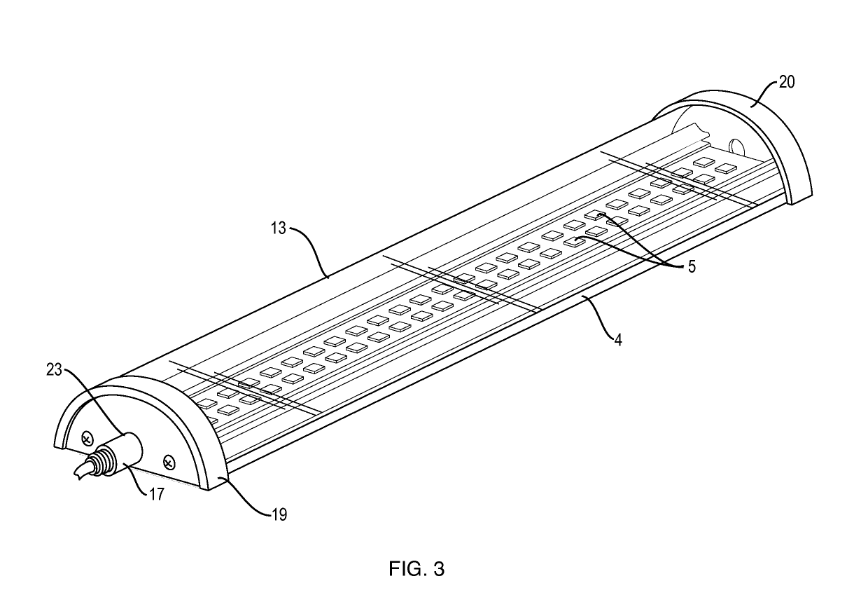

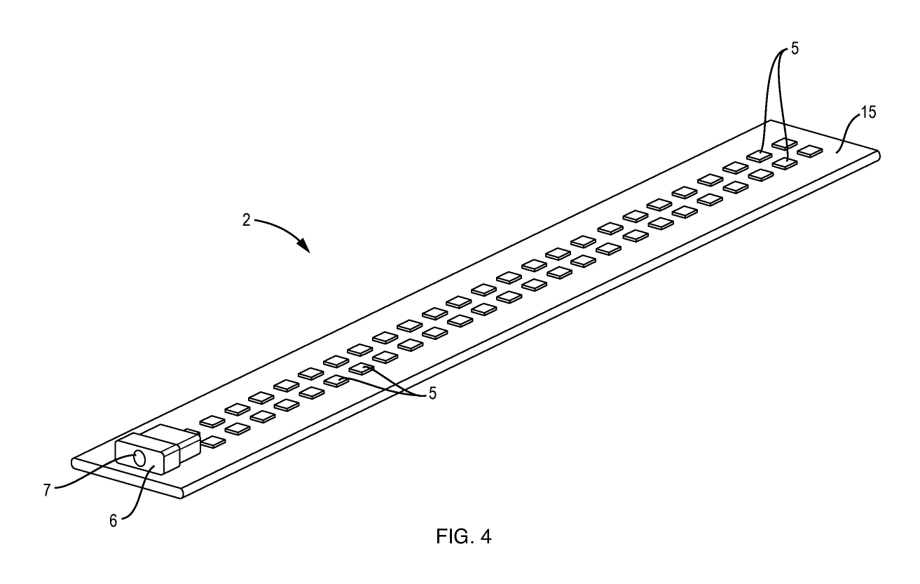

FIG. 3, Shows said LED board 2 of FIG. 1. About LED board 2 are a plurality of LED receptacles 5 located about top surface 15 (seen in FIG. 4) of said LED board 2. About bottom surface 16 of said LED board are a plurality of recesses which are operably connected to the electrical circuit; a configured plug socket 7 integrally formed at an opposing end 10 of the unit; and wherein the plug socket 7 and configured plug 17 provide for removable, friction-fit, latchless, and electrical interconnection of one or more circuits. In another embodiment said plug socket 7 can be mounted to the substrate by any means including by soldering directly to electrical contacts on the substrate or by adhering the plug socket 7 to the substrate mechanically with screws, rivets, or with glue to name a few examples, while ensuring acceptable contact between the plug and circuit of the unit.

In FIG. 4, the interfacing surface 9 of base 4 is shown. Groove 9 of interfacing surface of base 4 is configured to receive similarly shaped magnets 8. Base 4 of the unit is mounted in a proximity that allows thermal contact with the existing fixture. The material of the magnetic aspects of the unit provides a heat sink whereby heat is moved away from the lens 13 (not shown). Thus, the magnetic aspects 8 of the interfacing surface 4 of unit spread heat over a wider area of the unit 1, which in turn transfers heat to the ambient air. Effective heat dissipation is achieved by taking advantage of the large surface area of both the magnetic aspects 8 of the interfacing surface 4 of the unit.

In FIG. 5, A top front view of the assembled unit is shown. Covering lens 13 encases the unit 1 of FIG. 1. End caps 10 and 20 (not shown) provide a sealed environment for unit 1 of FIG. 1. End cap 10 has three ports 21, 22, and 23. Opening 23 provides access from configured plug 17 to connect in to plug socket 7. Configured plug 17 is coupled to external electrical cord 26. Electrical cord 26 couples with plug socket 7 via port 23 wherein the configured plug 17 electrically connects to the device via an external or internal driver 25 of FIG. 1. Ports 21 and 22 provide a means for affixing said end caps 10 and 20 respectively to said unit.

What has been described here and above is the preferred embodiment of the invention those skilled in the art will recognize that numerous changes may be made without departing from the spirit and scope of the invention.

1. An adapted apparatus for securing a light emitting diode (LED) unit designed to be mounted to an existing fixture comprising: a housing, a reflector surface, a non-interfacing surface, an interfacing surface, a plurality of magnetic elements, a plurality of magnetized elements, a plurality of recesses along the non-interfacing aspect of said case, an LED array mounting array located on said non-interfacing surface, a power supply receptacle on an end aspect of said case that is electrically connected to said existing fixture to provide an electrically conductive path between said existing fixture and said light emitting diode (LED) unit, a tube ballast, a lens cover, and a lens.

2. The light emitting diode unit of claim 1, wherein said interfacing surface of said case includes a plurality of magnetic elements attached about said interfacing surface.

3. The light emitting diode unit of claim 2, wherein said magnetic elements may be in the form of strips or magnetized aspects along said interfacing surface.

4. The light emitting diode unit of claim 2, wherein said non-interfacing surface of said case provides a plurality of recesses wherein aspects provide a plurality of LEDs.

5. The light emitting diode unit of claim 4, wherein said non-interfacing surface of said case provides a plurality of receptacles shaped to receive a plurality of LEDs.

6. The light emitting diode unit of claim 1, wherein said non-interfacing surface of said case provides a reflective surface about the area of the plurality of LEDs wherein aspects non-interfacing surface of said case provide receptacles shaped to receive a plurality of LEDs.

7. The light emitting diode unit of claim 1, wherein said light emitting diode unit possesses a power source receptacle that receives an electrical pathway from the existing fixture to said light emitting diode unit.

8. The light emitting diode unit of claim 1, wherein said non-interfacing surface of said case is covered by a multifaceted lens.

9. The light emitting diode unit of claim 8, wherein said multifaceted lens can have random or ordered patterns of facets.

10. The light emitting diode unit of claim 8, wherein said multifaceted lens may be made of polycarbonate, acrylic, or other members of a similar class of materials.

11. An adapted apparatus system for securing a light emitting diode (LED) unit designed to be mounted to an existing fixture comprising: a housing, a reflector surface, a non-interfacing surface, an interfacing surface, a plurality of magnetic elements, a plurality of magnetized elements, a plurality of recesses along the non-interfacing aspect of said case, an LED array mounting array located on said non-interfacing surface, a power supply receptacle on an end aspect of said case that is electrically connected to said existing fixture to provide an electrically conductive path between said existing fixture and said light emitting diode (LED) unit, a tube ballast, a lens cover, and a lens.

12. An adapted apparatus system for a light emitting diode unit of claim 11, wherein said side interfacing aspect comprises an case whereupon aspects of said case include a plurality of magnetic elements about said interfacing surface.

13. An adapted apparatus system for a light emitting diode unit of claim 12, wherein said magnetic elements may be in the form of strips or magnetized aspects along said interfacing surface.

14. An adapted apparatus system for a light emitting diode unit of claim 12, wherein said non-interfacing surface of said case provides a plurality of recesses wherein aspects provide a plurality of LEDs.

15. An adapted apparatus system for a light emitting diode unit of claim 14, wherein said non-interfacing surface of said case provides a plurality of receptacles wherein aspects provide said receptacles shaped to receive a plurality of LEDs.

16. An adapted apparatus system for a light emitting diode unit of claim 11, wherein said non-interfacing surface of said case provides a reflective surface about the area of the plurality of LEDs wherein aspects non-interfacing surface of said case provide receptacles shaped to receive a plurality of LEDs.

17. An adapted apparatus system for a light emitting diode unit of claim 11, wherein said light emitting diode unit possesses a power source receptacle that receives an electrical pathway from the existing fixture to said light emitting diode unit.

18. An adapted apparatus system for a light emitting diode unit of claim 11, wherein said non-interfacing surface of said case is covered by a multifaceted lens.

19. An adapted apparatus system for a light emitting diode unit of claim 18, wherein said multifaceted lens can have random or ordered patterns of facets.

20. An adapted apparatus system for a light emitting diode unit of claim 18, wherein said multifaceted lens may be made of polycarbonate, acrylic, or other members of a similar class of materials.
